(19) United States
(12) Patent Application Publication
(10) Pub. No.: US 2007/0101942 A1
(43) Pub. Date: May 10, 2007

(54) Changeable aquarium background setting

(76) Inventor: Robert L. Smith, Mentor, OH (US)

Correspondence Address: FAY SHARPE LLP, 1100 SUPERIOR AVENUE, SEVENTH FLOOR, CLEVELAND, OH, 44114, US

(21) Appl. No.: 11/593,961

(22) Filed: Nov. 7, 2006

Related U.S. Application Data
(60) Provisional application No. 60/734,731, filed on Nov. 8, 2005.

(51) Int. Cl. A01K 63/00

(52) U.S. Cl. 119/253

(57) ABSTRACT

According to the disclosure, there is provided a background device for an aquarium/terrarium having viewable walls, comprising a first roller mounted adjacent to an edge of a wall and a second roller mounted adjacent to another edge of the same wall or another wall. The first and second rollers include a rotatably changeable background scenery therebetween to substantially cover at least one of the viewable walls.

### CROSS REFERENCE TO RELATED APPLICATION

This application claims priority from U.S. Provisional Patent Application Ser. No. 60/734,731 filed Nov. 8, 2005 and is expressly incorporated herein by reference, in its entirety.

### BACKGROUND

The disclosure relates to a changeable decorative background or scenery for an aquarium or terrarium. Aquariums/terrariums are typically used for keeping living animals, fish, and/or plants. Millions of people keep fish and other pets in aquariums/terrariums or various other viewable enclosures. Of great concern to most owners is the appearance of the aquarium itself, which complements and adds to the visual display offered by the fish, for example, within the aquarium.

The provision of a background scenery, typically in the form of a background sheet, to aquariums is known. The background scenery creates a more realistic and attractive living habitat or environment. The background sheet is usually fixedly attached to the back of the tank. In this mounting arrangement, accumulation of unwanted substance such as moisture or dust between the tank and the sheet is inevitable. This accumulation fouls the scenery and the resultant display thereby requiring periodic changing of the background sheet. Due to the fixed attachment of the background sheet to the back of the tank, changing the background scenery is cumbersome. For internal mounting arrangements, the owner must first remove the fish within the tank, and all of the other contents of the tank, thereby allowing access to the background sheet and removal thereof. For external mounting arrangements, the existing background sheet must be removed, the remnant adhesive removed, new adhesive applied, and a new sheet fixedly attached to the tank. The other drawback for the above described alternatives is that the background remains the same except for when the sheet is completely, albeit cumbersomely, replaced.

The disclosure described below seeks to alleviate such problems by providing an improved background setting for an aquarium, terrarium, or any other viewable enclosure.

### SUMMARY

According to the disclosure, there is provided a background device for an aquarium having viewable walls, comprising a first roller mounted adjacent to a top edge of a rear wall. The device further includes a second roller mounted adjacent to a bottom edge of the rear wall. The first and second rollers include a rotatably changeable background scenery therebetween to cover at least the rear wall.

According to the disclosure, there is provided a method for changeably displaying an aquarium background scenery. The method comprises providing a first roller to an exterior surface of the aquarium; providing a second roller to the exterior surface of the aquarium spaced from the first roller; providing a background scenery between the first roller and the second roller facing into the aquarium; and, moving the background scenery, back and forth, from the first roller to the second roller.

Further according to the disclosure, there is provided a changeable background scenery for a viewable enclosure comprising a first roller mounted to the enclosure and a second roller mounted to the enclosure spaced from the first roller. A first rollable background scenery is provided and extends between the first roller and the second roller facing into the enclosure.

### BRIEF DESCRIPTION OF THE DRAWINGS

FIG. 1 is a perspective view of an aquarium and a decorative background assembly according to a first embodiment;

FIG. 2 is a top plan view of FIG. 1 partially in section;

FIG. 3 is a side plan view of FIG. 1 partially in section;

FIG. 4 is a perspective view of the decorative background assembly;

FIG. 5 is a perspective view of the decorative background assembly and an adjustable timer adapted for controlling the movement of said assembly;

FIG. 6 is a plan view of a decorative scroll having discrete scenes;

FIG. 7 is a plan view of a decorative scroll having a continuous scene;

FIG. 8 is a partial front elevational view of an adjustably sized decorative scroll;

FIG. 9 is a cross sectional top view of the decorative background assembly including adjustable rollers;

FIG. 10 is a cross section side view of one roller of the decorative background assembly;

FIG. 11 is a perspective view of a second mounting arrangement of the decorative background assembly;

FIG. 12 is a side view of the mounting arrangement of FIG. 11;

FIG. 13 is a perspective view of a second embodiment of the decorative background assembly including a third mounting arrangement;

FIG. 14 is a side view of the mounting arrangement of FIG. 13;

FIG. 15 is a perspective view of the second embodiment of the decorative background assembly including a fourth mounting arrangement; and,

FIG. 16 is a partial cross sectional side view of the mounting arrangement of FIG. 15.

### DETAILED DESCRIPTION

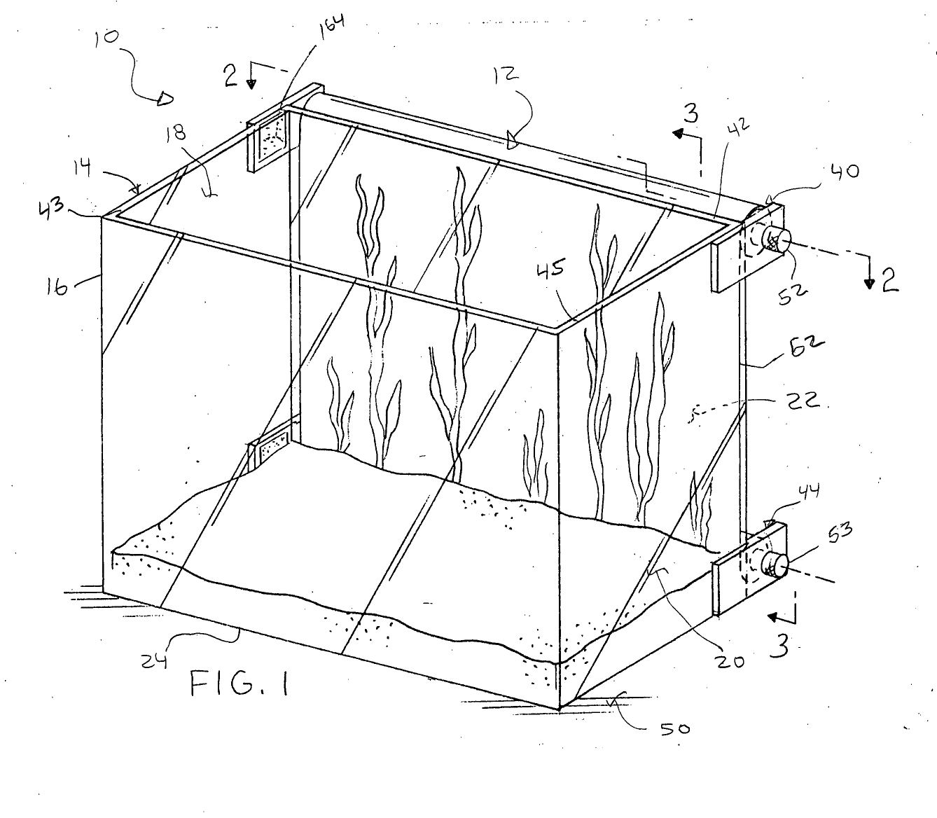

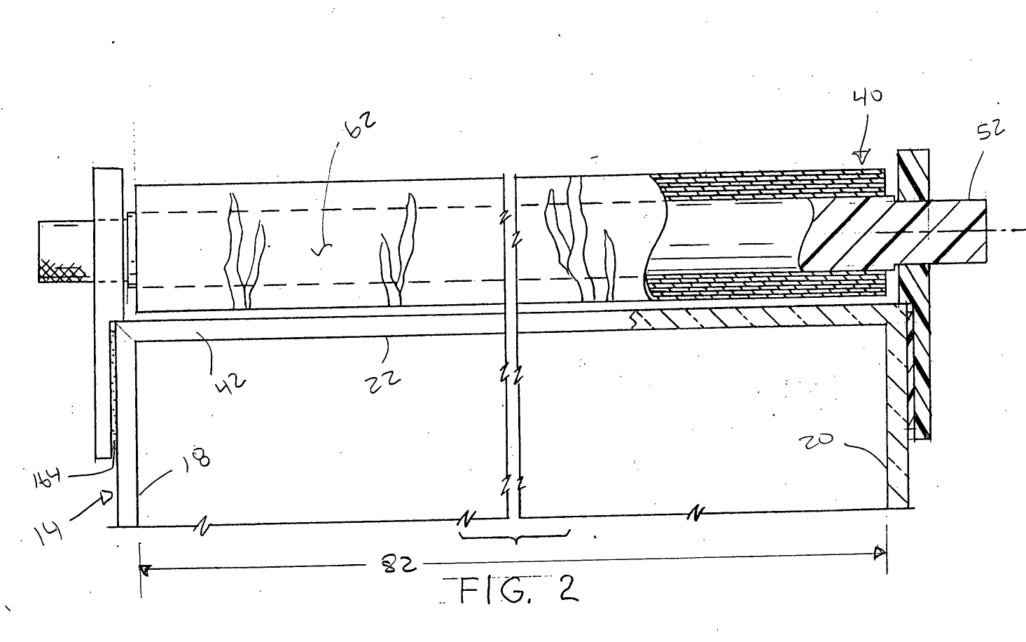

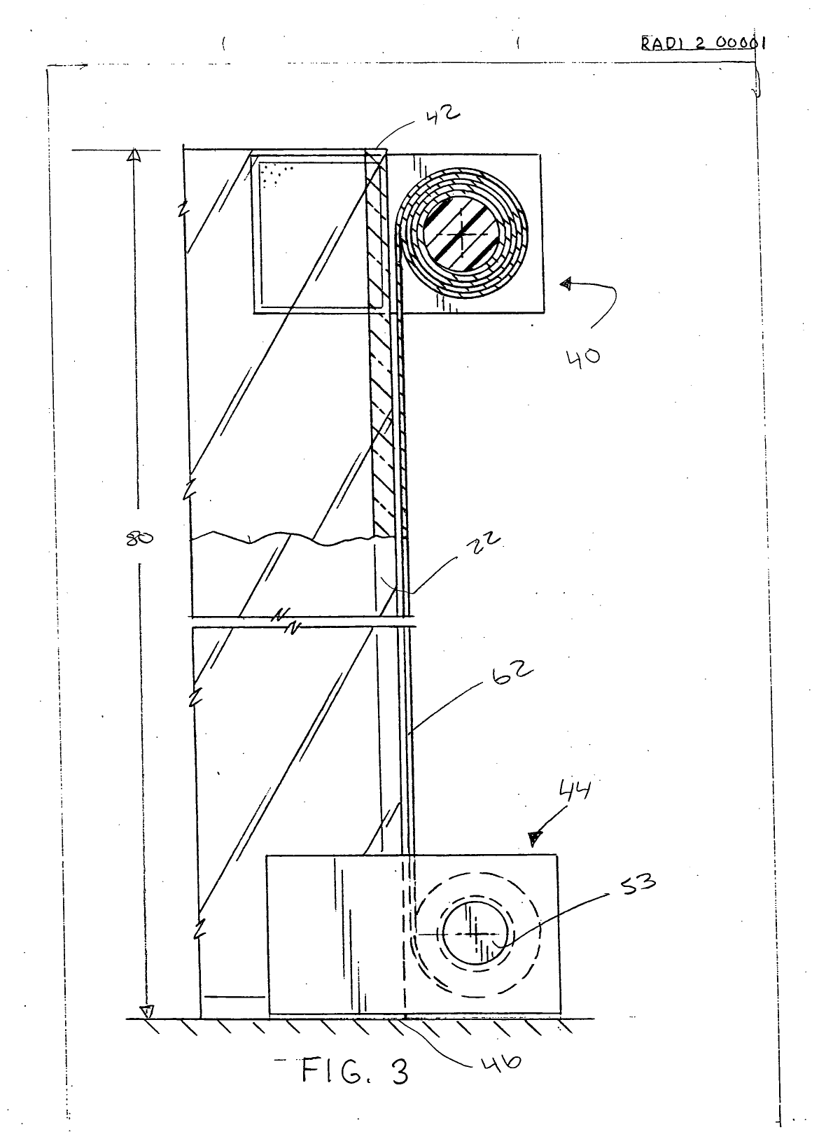

Referring to the drawings, there is shown an aquarium/terrarium 10 incorporating a background setting assembly 12 embodying the disclosure. As shown in FIGS. 1-4, an aquarium can include, for example, an integrally molded plastic tank or glass tank 14 of a square, rectilinear, curvilinear, or other shaped structure for containing water to keep living aquatic animals or plants. Similarly, a terrarium can include a similar structure for containing insects, snakes, hampsters, etc. The tank 14 can have a transparent front wall 16, left and right side walls 18, 20, a rear wall 22 and a bottom wall 24. It is to be appreciated, for a rectilinear tank, that the left and right side walls 18, 20 are typically of a smaller dimension than the front and rear walls 16, 22. The aforementioned arrangement can result in a rectangular, rectilinear, curvilinear, etc. enclosure or tank which can be of any number of sizes. The various sizes of the tanks can be categorized by the number of gallons, i.e., volume, contained therein. A top lid (not shown) normally closes the tank 14 for retaining the inhabitants therein and for providing a mounting structure for a light, filter, etc.

As described above, the front 16, rear 22, bottom 24, and side walls 18, 20 can define a rectilinear structure with a selectively closeable top. According to a first embodiment, the rear wall 22 can include a first or top scroll roller 40 mounted adjacent to or on a top edge 42 and a corresponding second or bottom scroll roller 44 mounted adjacent to a bottom edge 46. It is to be appreciated that the mounting of the bottom roller 44 can be such to provide uninhibited placement of the tank, for example, flush with a cabinet, shelf, or table 50 located thereunder. Further, the rollers 40, 44 can be mounted such that rotation of the rollers is unencumbered by the placement of the tank 14. According to the first mounting arrangement, the pair of scroll rollers 40, 44 can be mounted in a horizontal orientation relative to the rear or back wall 22 of the tank 14. Roller 40 can include a knob 52, or similar, for manually turning the roller 40. Similarly, roller 44 can include a knob 53 for manually turning the roller 44.

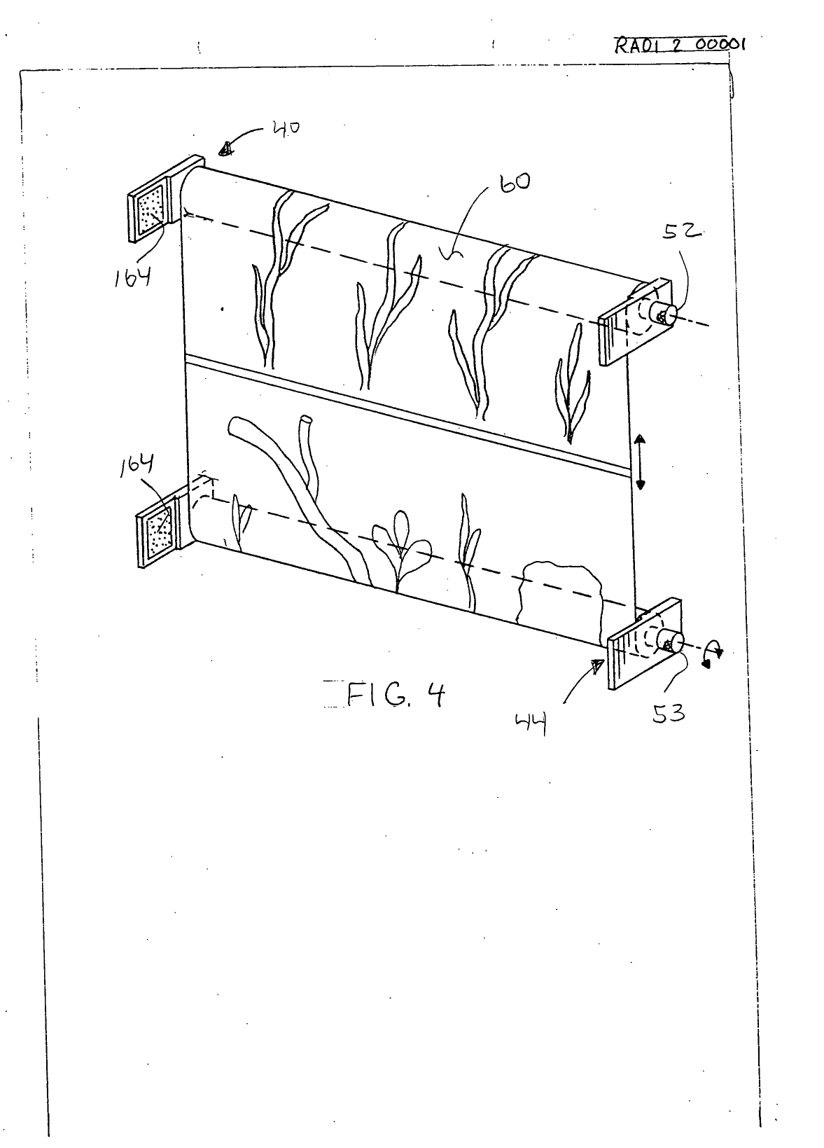

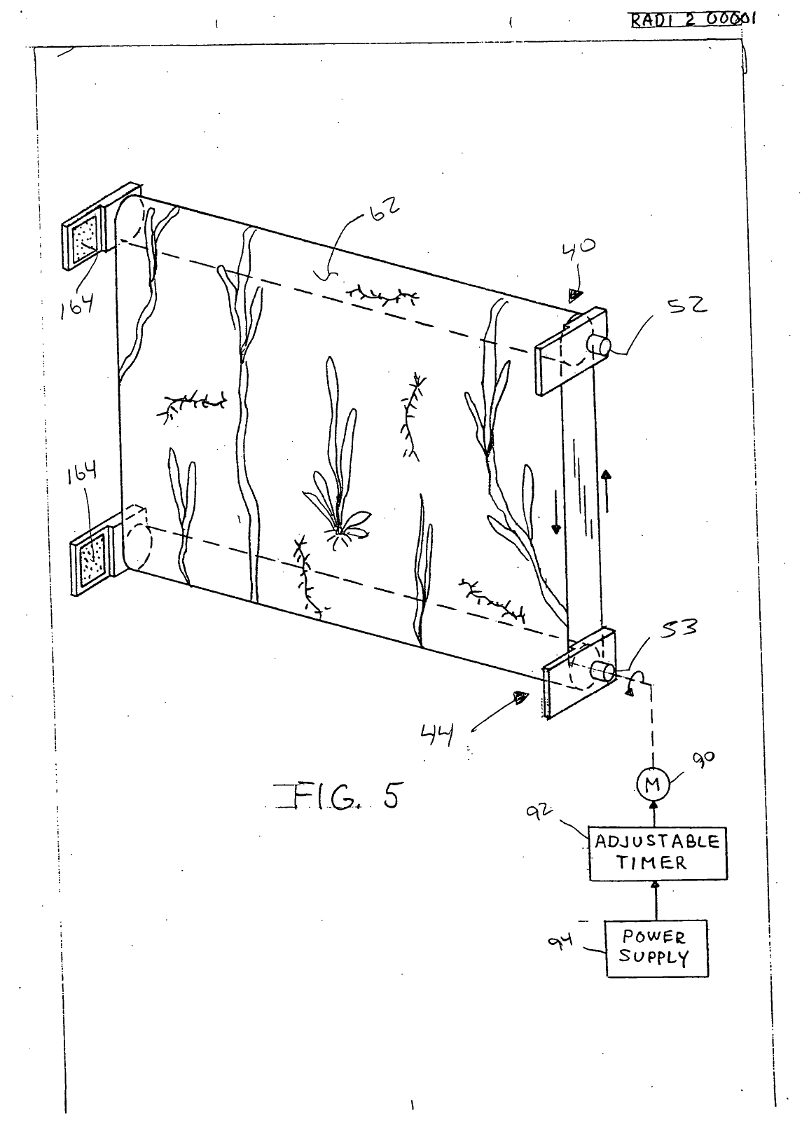

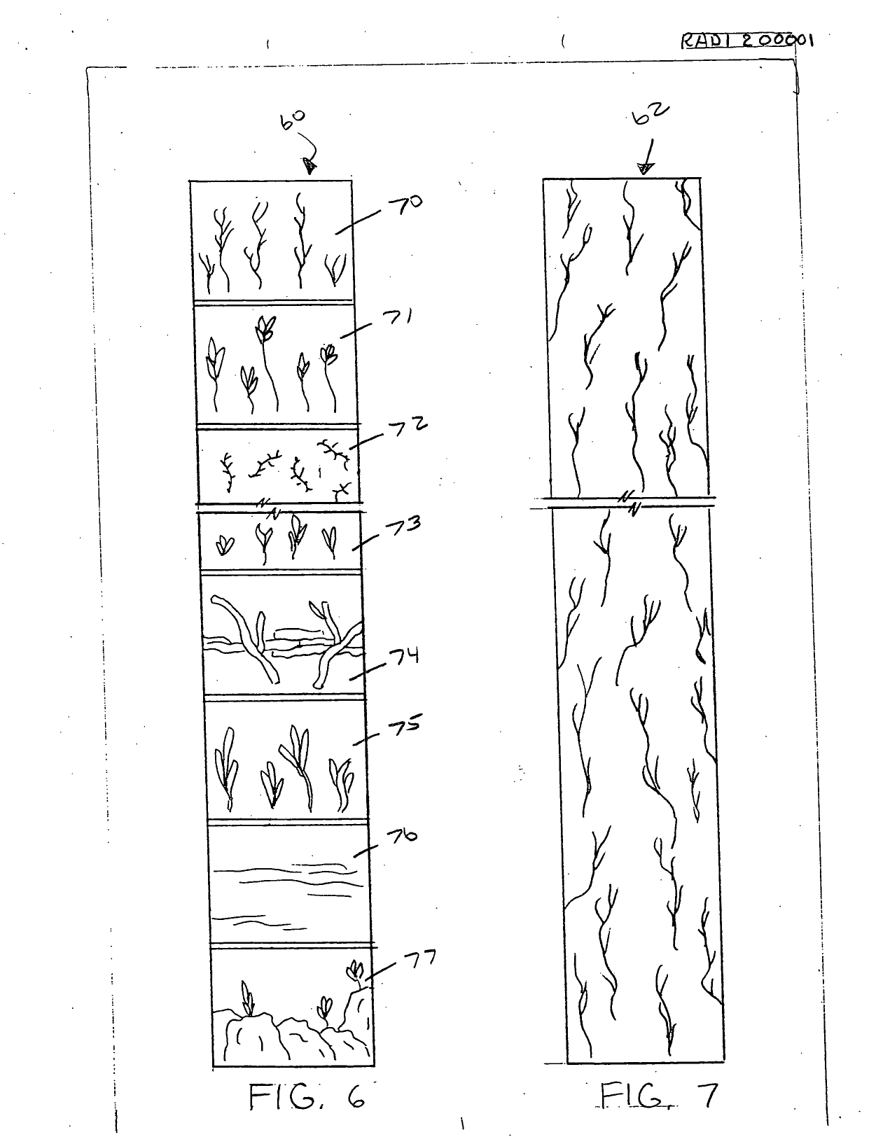

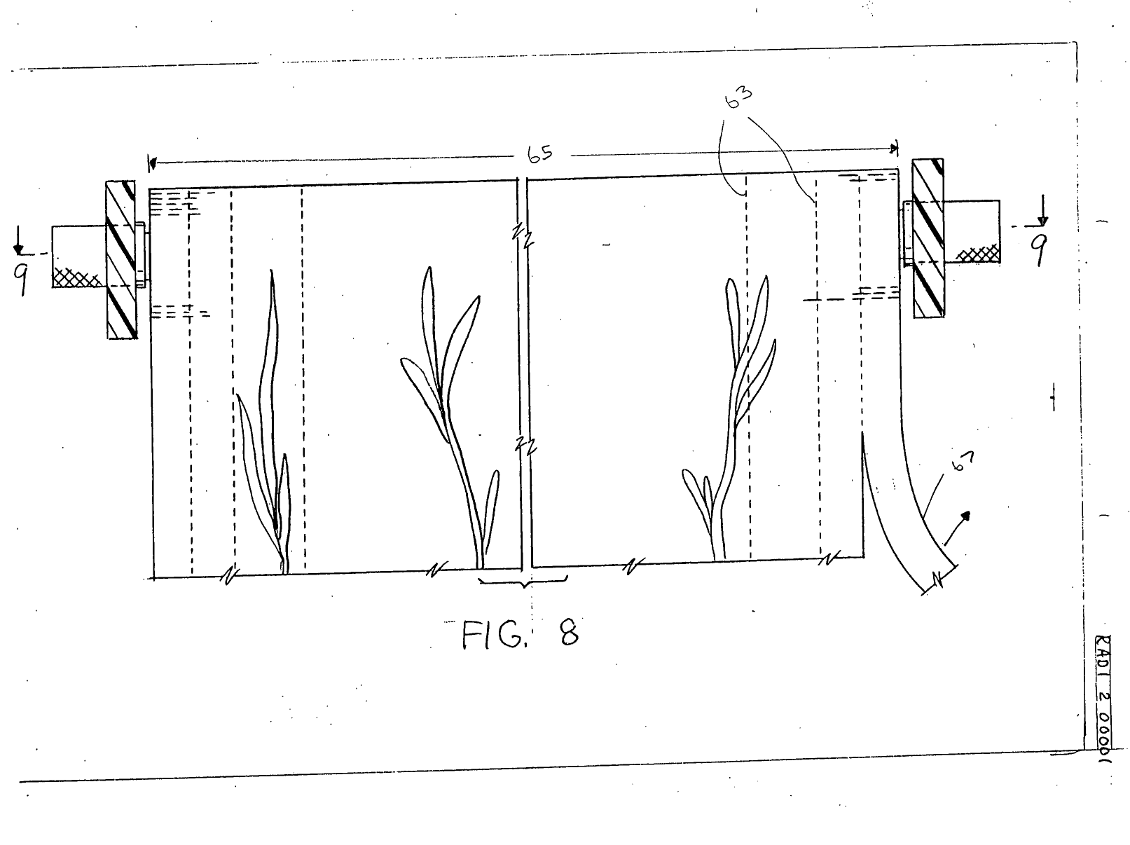

A background scenery sheet or sheet roll 60, having opposite ends (FIG. 4) or a continuous loop 62 (FIG. 5), can be wound on the pair of scroll rollers 40, 44. The scenery sheet 60, 62 can be positioned between the rollers and can be displayed such that one looking through the front wall 16, side walls 18, 20, and the interior of the tank will view a portion of the scenery sheet 60, 62. In this manner a portion of the scenery sheet roll is viewed through the front wall (and/or side walls), interior, and back wall of the tank. The scenery can be either a continuous scene 62, as detailed in FIG. 7, or a multitude of discretely printed scenes 70, 71, 72, 73, 74, 75, 76, and 77 compiled on one roll 60, as detailed in FIG. 6. The discrete scenes 70-77 can have a size in conformance with the size of the tank, i.e., at least substantially the height 80 and width 82 of the rear wall. The continuous scene 62 provides the feature of changing as little or as much of the scene as the user desires. As shown in FIG. 5, the continuous scene 62 (or discrete scenes) may comprise a loop of scenery around the pair of rollers 40, 44.

In use, the background 60, 62 can easily be changed from one scene to another by simply rotating the rollers, for example back and forth, a selected amount. In the case of the scenery having discrete scenes 60, rotation of the rollers, in one example, can include advancing the sheet from an end of one scene 70 to an end of another scene 71, skipping to the end of still another scene 73, or advancing/reversing the rollers to still any other scene 76. The number of discrete scenes can be any number of scenes, limited only by the length of the sheet roll 60. In the case of a continuous background scenery 62, the rollers can be rotated in either direction as little or as much as desired in order to reflect a varied background scenery. It is to be appreciated, that the background scenery can include a continuous loop around the pair of rollers 40, 44 such that only one roller manually or automatically driven in a single direction will provide the necessary means for continuously movement of the background scenery. It is also to be appreciated that at least one of the rollers can be controlled by a motor 90 (FIG. 5) for selective automatic rotation of the roller 44 and the associated scenery roll 62. The rate of rotation can be controlled by an adjustable timer 92 to vary the elapsed time, frequency, timing, amount of advancement, etc. for controlling the changing of the scene. The motor 90 and timer 92 can be connected to a power supply 94, such as, for example, a battery or electrical outlet.

The sheet rolls 60, 62 can have a variety of displays and colors. The displays can be simulated ‘natural’ environments (i.e. marine, desert, etc.) desired for the inhabitants within the enclosure or can be any other display the owner fancies.

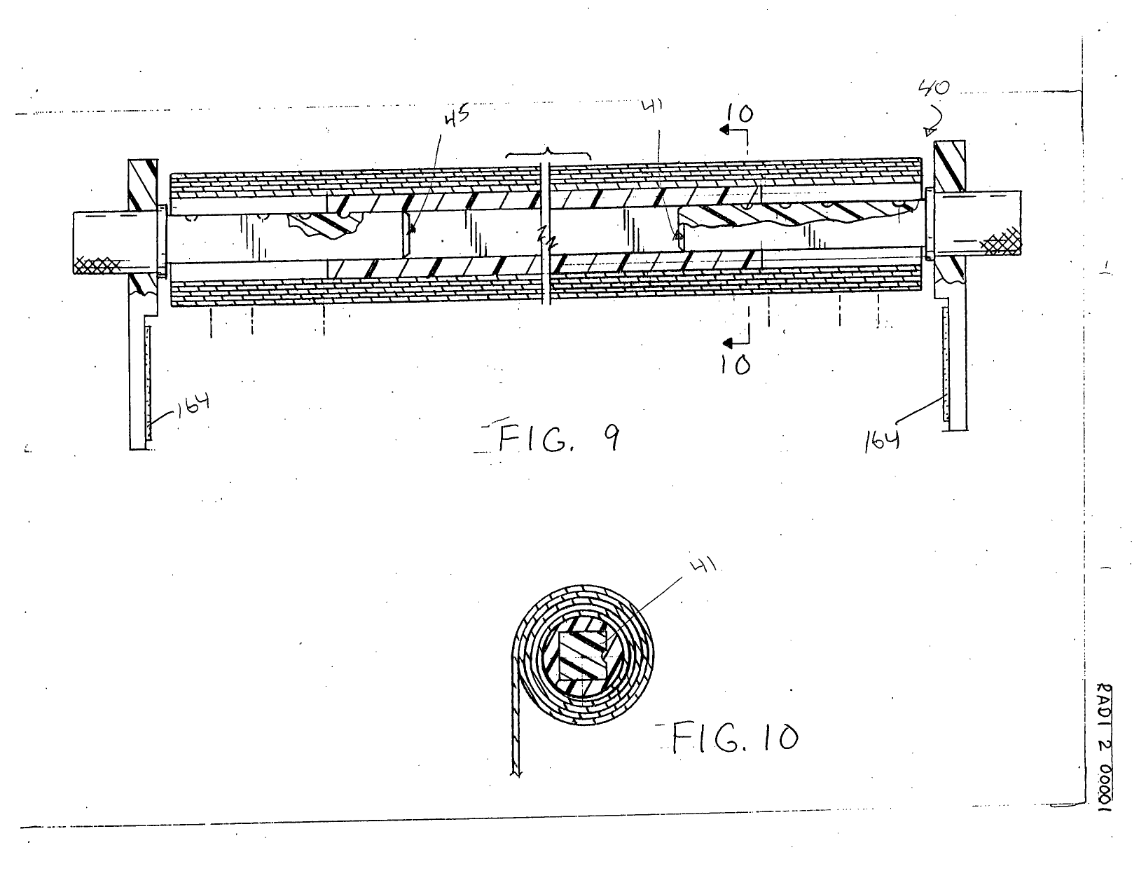

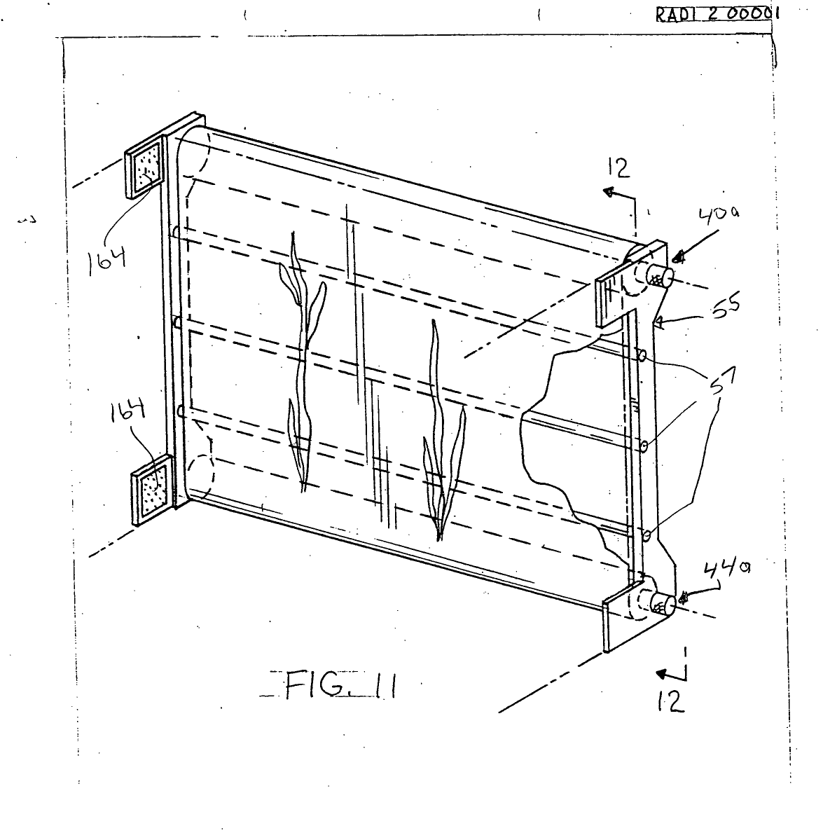

As shown in FIG. 9-10, the rollers 40, 44 can include telescoping rods 41, 45 for effectively changing the dimension (length) of the rollers 40, 44 in association with different sized tanks, i.e., dimension of rear wall 82. It is to be appreciated that the background scenery can include perforated sections 63 (FIG. 8) that can be selectively torn off, cut or removed in order to adjust the dimension, i.e. width 65 or height (not illustrated), of the scenery sheet in conjunction with the changing dimension (telescoping) of the rollers. Thus, the desired width or height can be achieved by tearing off or cutting the unnecessary sections 67 and sliding the telescoping rods inward in conformance with the tank dimensions.

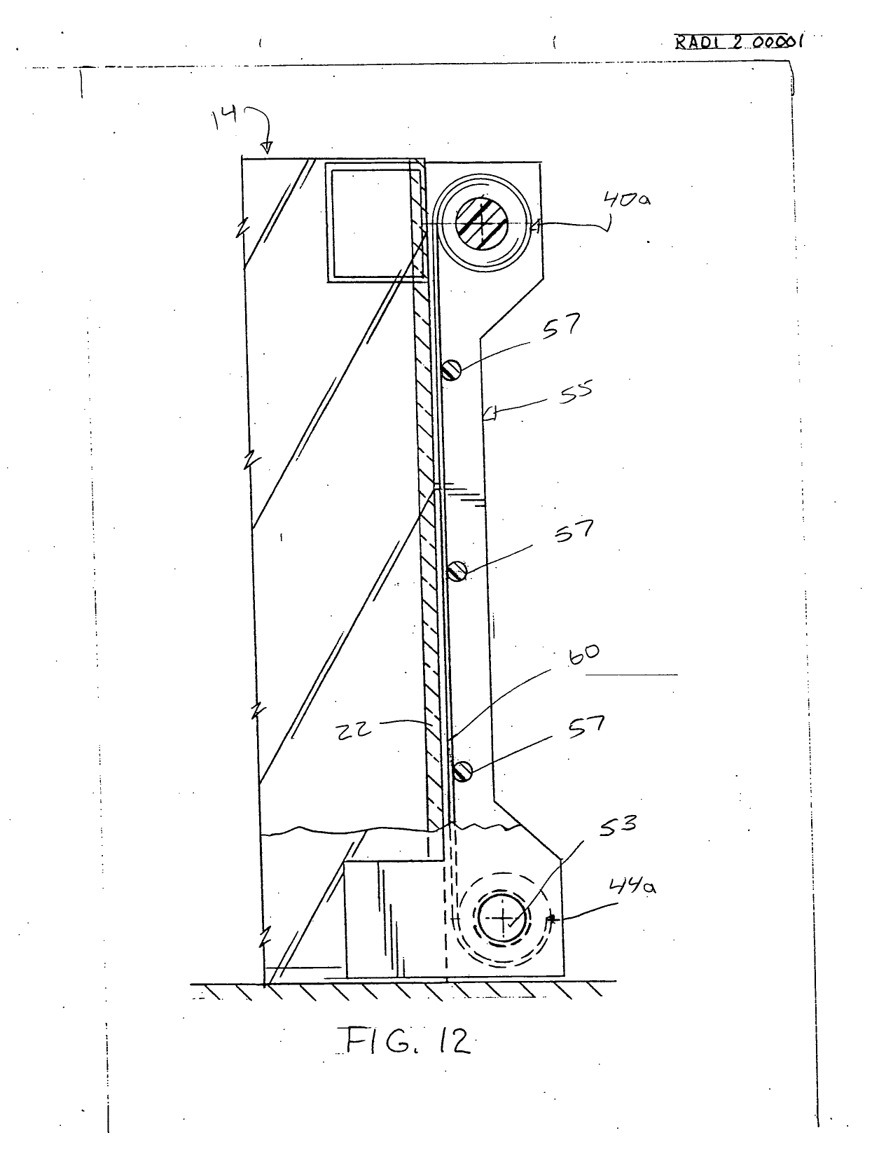

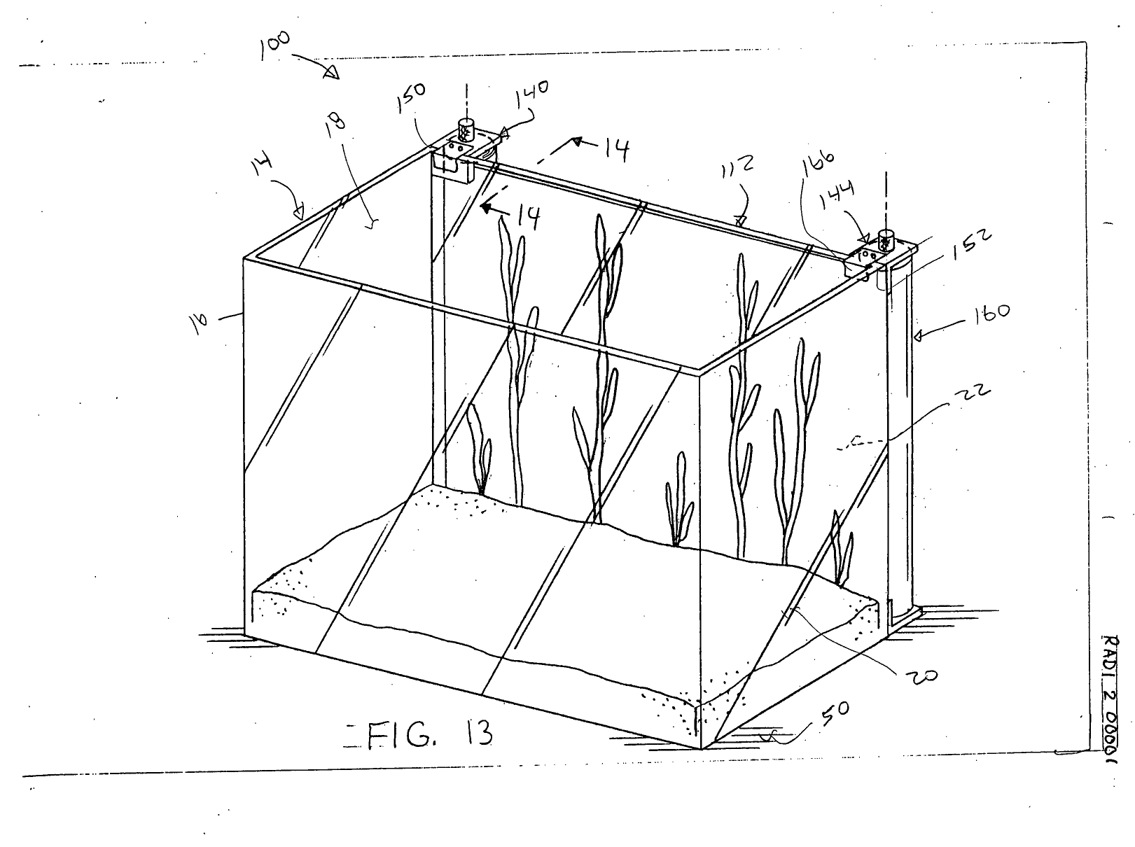

Referring now to FIGS. 11-12, wherein another mounting arrangement is therein shown. Roller 40a, 44a can be mounted within a supporting frame 55. The mounting frame 55 supports the rollers 40a, 44a and assists in maintaining their orientation relative to the tank 14. The mounting frame 55 can further include a plurality of supporting rods 57 for maintaining the scenery rolls adjacent to the back wall 22 of the tank 14. Referring to FIG. 12, it is to be appreciated that the viewable portion of the scenery roll passes between the supporting rods 57 and the exterior of back wall 22 thereby maintaining the viewable portion of the scenery roll in close proximity to the back wall 22.

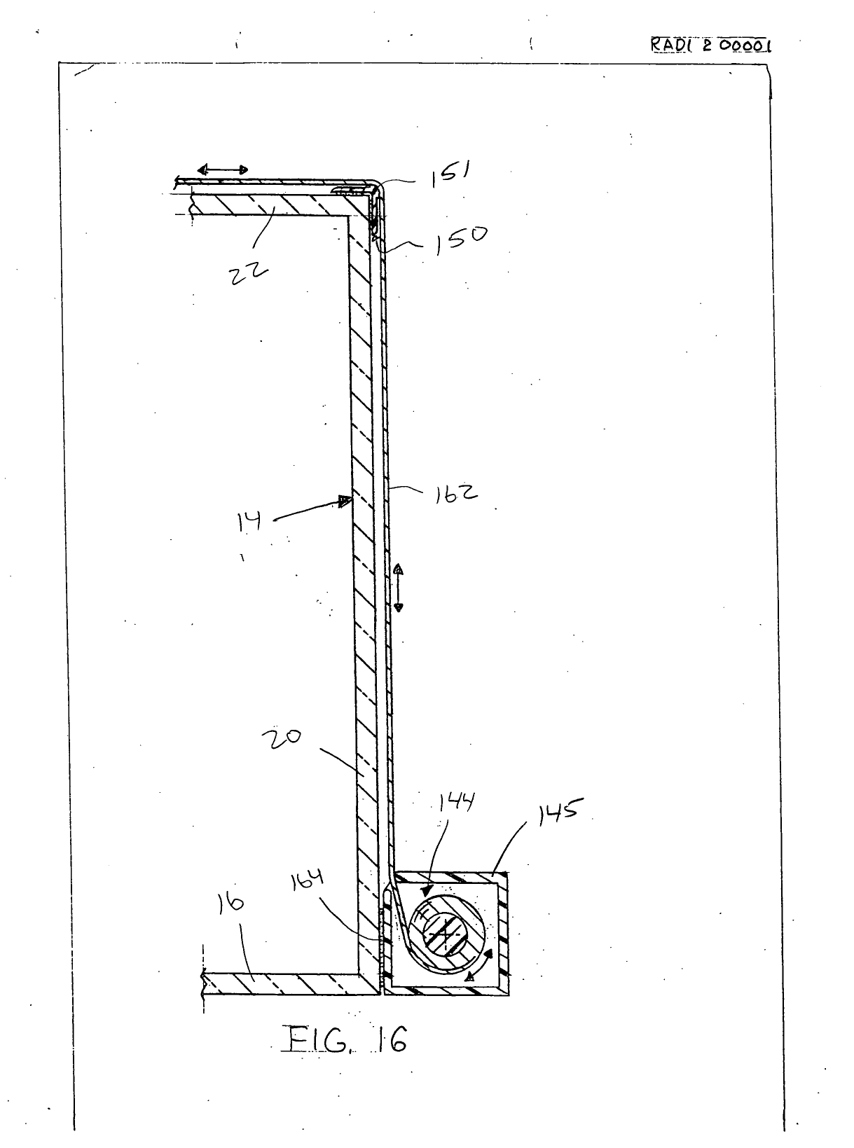

Referring now to FIGS. 13-16 wherein a second embodiment 100 of the decorative background assembly 112 including a scenery sheet roll 160 is therein shown. In one exemplary mounting arrangement, the rear wall 22 can include a first or left scroll roller 140 mounted adjacent to a left edge 150 and a corresponding second or right scroll roller 144 mounted adjacent to a right edge 152. It is to be appreciated that the mounting of the left and right rollers 140, 144 can be such to provide uninhibited placement of the tank, for example, flush with a shelf or table 50 located thereunder. Further, the rollers 140, 144 can be mounted such that rotation of the rollers is unencumbered by the placement of the tank. In another exemplary mounting arrangement, as shown in FIG. 15, the pair of scroll rollers 140, 144 can be mounted in a vertical orientation proximal to opposing sides of the front wall 16 of the tank 14. It is to be appreciated that the mounting configuration shown in FIG. 15-16 can be nearly flush with a wall therebehind (not illustrated). A continuous scrolling scenery sheet roll 162 can ‘travel’ first from one side 18, across the back wall 22, and around an opposing side 20, and then can ‘travel’ back in a reverse direction. Each of the rollers 140, 144 can include a frame 141, 145 to conceal and protect the scenery roll 162 therein. The tank 14 can include corner mounts 150 for supporting the scenery sheet roll 162 and providing adequate spacing as it travels around the tank 14. It is to be appreciated that the mounts 150 also provide a curvilinear surface 151 at the intersections of the respective side wall 18, 20 and the back wall 22 of the tank 14 thereby reducing wear on the sheet roll 162.

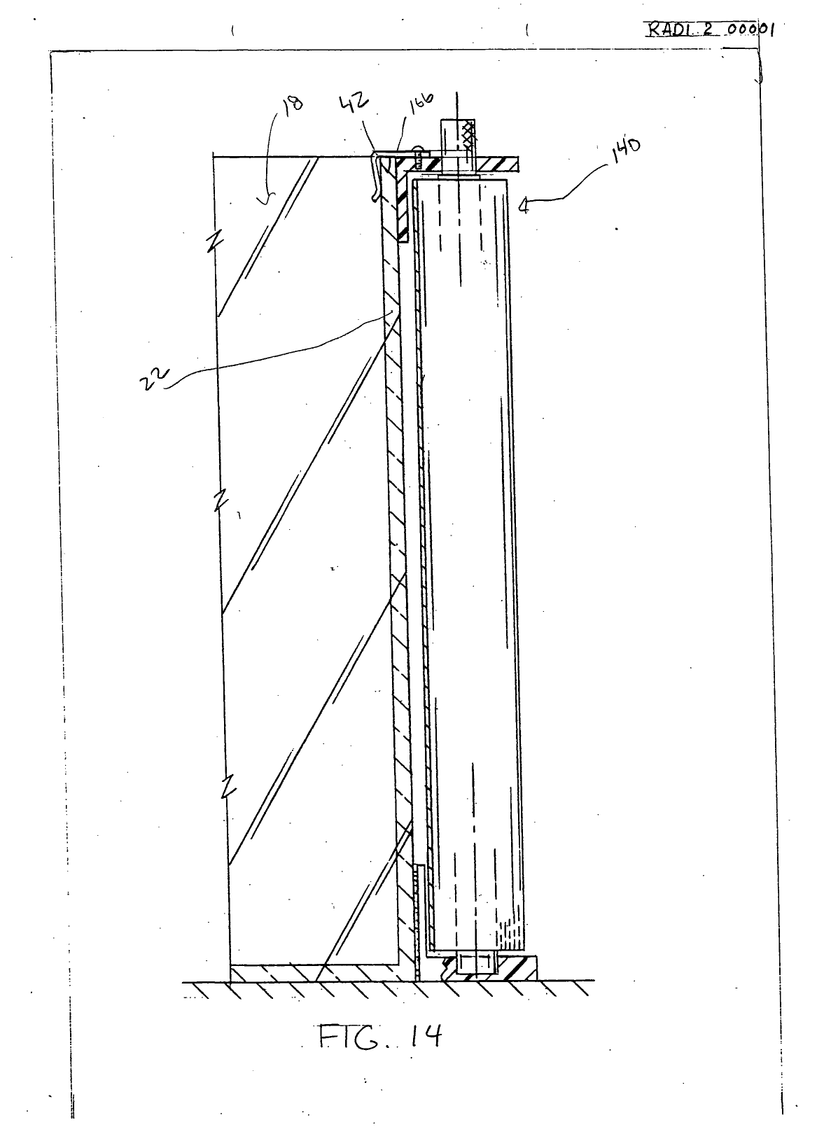

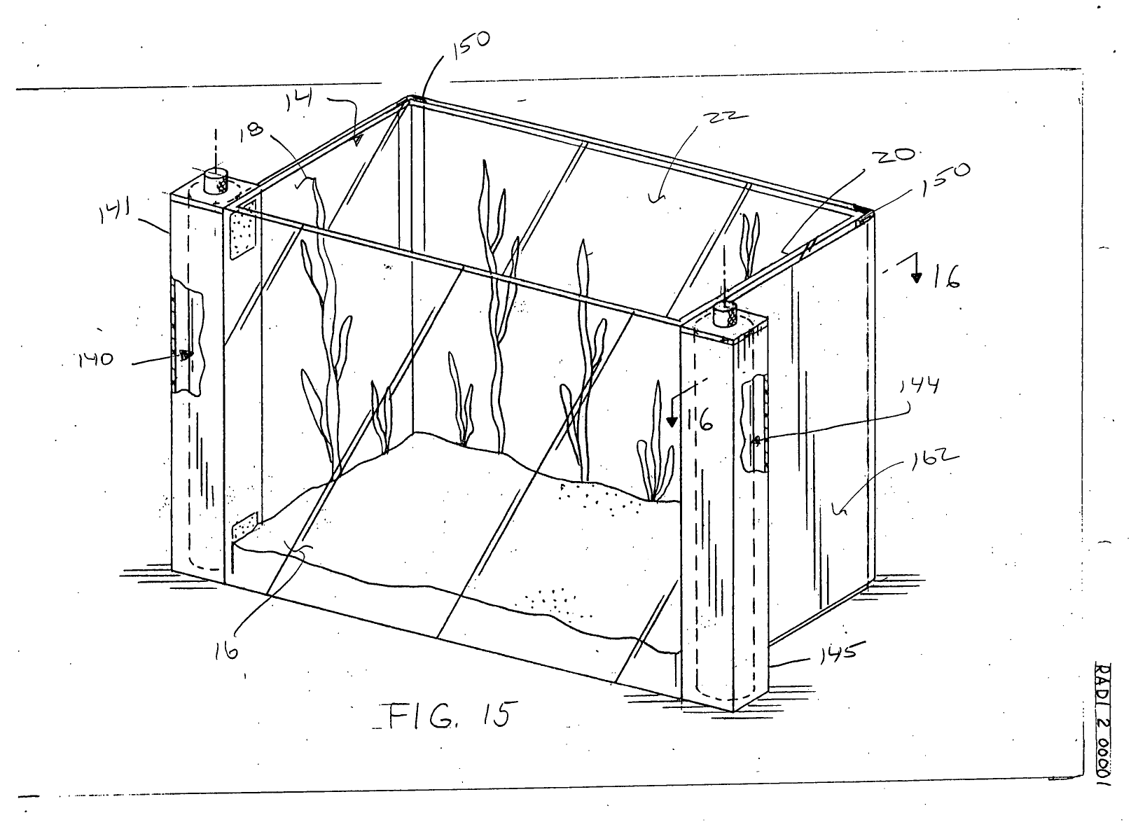

It is to be appreciated that the mounting of the rollers can be by any number of conventional means including clip and double sided adhesive tape. The mounting can be adapted to not interfere with other periphery equipment associated with an aquarium or terrarium. The rollers 40, 44, 40a, 44a, 140, 144 can include a generally planer mounting surface having adhesive faces 164 on opposing ends for attaching to the exterior of the tank walls. Alternatively, the roller mount(s) can include clips 166 (refer to FIGS. 14 and 15) for engaging a top edge 42 of the back wall or top edges 43, 45 of the side walls 18, 20 of the tank.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

1. A background device for an aquarium having viewable walls, said background device comprising:
a first roller mounted adjacent to a top edge of a rear wall;
a second roller mounted adjacent to a bottom edge of said rear wall; and,
said first roller and said second roller including a rotatably changeable background scenery therebetween to substantially cover at least said rear wall.

2. The background device according to claim 1, wherein said first roller is mounted to the rear wall and said second roller is mounted to the rear wall.

3. The background device according to claim 1, wherein said first and second rollers are adhesively mounted to the rear wall.

4. The background device according to claim 1, wherein said first roller includes at least one clip for mounting to a top edge of the rear wall of the aquarium.

5. The background device according to claim 1, wherein said first and second rollers rotate in one direction thereby moving said background scenery in one rotational direction.

6. The background device according to claim 1, wherein said background scenery moves from said first roller to said second roller in a first direction.

7. The background device according to claim 6, wherein said background scenery moves from said second roller to said first roller in a second direction.

8. The background device according to claim 6, wherein said moving of said background scenery is manually driven.

9. The background device according to claim 6, wherein at least said first roller includes a motor to continuously rotate said first roller thereby moving said background scenery in at least one direction.

10. An aquarium background scenery displaying method for changeably displaying a scenery comprising:
a) providing a first roller to an exterior surface of the aquarium;
b) providing a second roller to the exterior surface of the aquarium spaced from said first roller;
c) providing a background scenery between said first roller and said second roller facing into the aquarium; and,
d) moving said background scenery from said first roller to said second roller in a first direction.

11. The method of claim 10, further comprising:
e) moving said background scenery from said second roller to said first roller in a second direction.

12. The method of claim 10, further comprising:
f) exchanging said background scenery with another background scenery.

13. The method of claim 10, wherein at least one of said first and second rollers includes a knob wherein said background scenery is moved manually by rotating said knob.

14. The method of claim 10, wherein said background scenery is moved automatically by a motor driving at least one of said first and second rollers in at least said first direction.

15. A changeable background scenery for a viewable enclosure, comprising:
a first roller mounted to the enclosure;
a second roller mounted to the enclosure spaced from said first roller; and,
a first rollable background scenery extending between said first roller and said second roller facing into the enclosure.

16. The changeable background scenery according to claim 15, wherein said background scenery alternately moves in a first direction from said first roller to said second roller and in a second direction from said second roller to said first roller.

17. The changeable background scenery according to claim 15, wherein said first roller is mounted along a top edge of the enclosure and said second roller is mounted along a bottom edge of the enclosure.

18. The changeable background scenery according to claim 15, wherein said first said roller is mounted to a top edge of the enclosure.

19. The changeable background scenery according to claim 15, wherein said first and second rollers include telescoping rods adapted to be extended and retracted based on the dimensions of the enclosure.

20. The changeable background scenery according to claim 15, wherein said background scenery includes a continuous scene.

21. The changeable background scenery according to claim 15, further including at least a second rollable background scenery for exchanging with said first rollable background scenery thereby providing another background scenery facing into the enclosure.

22. The changeable background scenery according to claim 15, wherein said first roller is mounted proximal to a front edge of the enclosure and said second roller is mounted to another front edge such that said scenery substantially extends along a first side, a rear side, and a second side of said enclosure.
